(19) United States
(12) Patent Application Publication
(10) Pub. No.: US 2018/0039708 A1
(43) Pub. Date: Feb. 8, 2018

(54) MULTI-REFERENCE EVENT SUMMARIZATION

(71) Applicant: Primer Technologies, Inc., San Francisco, CA (US)

(72) Inventors: Sean Gourley, San Francisco, CA (US); Richard Stebbing, San Francisco, CA (US); Amy Heineike, Albany, CA (US); Leonard Apeltsin, Berkeley, CA (US); Emmanuel Yera, San Francisco, CA (US)

(21) Appl. No.: 15/671,329

(22) Filed: Aug. 8, 2017

Related U.S. Application Data
(60) Provisional application No. 62/372,068, filed on Aug. 8, 2016.

(51) Int. Cl. G06F 17/30; G06Q 10/06

(52) U.S. Cl. CPC G06F 17/30873; G06F 17/3061; G06Q 10/06; G06F 17/30094; H04L 41/0803

(57) ABSTRACT

Systems, methods, software and apparatus enable generating a multi-reference event summary, an event detection module monitors one or more information sources. A collection module receives instructions from the event detection module to collect references that relate to a detected event. Collected references can be evaluated for their suitability and content and may be provided to a summarizing engine by the collection module. Various references may be used to obtain character strings that can be assembled to create the event summary. Moreover, additional content relating to the detected event may be appended to enhance the summary and metadata (e.g., regarding references considered, utilized, etc.) attached to and/or included in the event summary.

### RELATED APPLICATIONS

This application hereby claims the benefit of and priority to U.S. Provisional Patent Application No. 62/372,068, titled “MULTI-REFERENCE EVENT SUMMARIZATION,” filed Aug. 8, 2016, and which is hereby incorporated by reference in its entirety.

### TECHNICAL BACKGROUND

Various techniques have been developed for summarizing data. However, summarization of existing references has been limited to summarizing single references. The review, evaluation and digesting or condensation of multiple sources of information is often required or desirable in a variety of settings. Moreover, selecting references pertaining to a specific event is time-consuming and often lacks the thoroughness that is sometimes required.

### OVERVIEW

In some implementations of systems, methods, apparatus, etc. for generating a multi-reference event summary, an event detection module monitors one or more information sources. A collection module receives instructions from the event detection module to collect references that relate to a detected event. Collected references can be evaluated for their suitability and content and may be provided to a summarizing engine by the collection module. Various references may be used to obtain character strings that can be assembled to create the event summary. Moreover, additional content relating to the detected event may be appended to enhance the summary and metadata (e.g., metadata about the references from which data was selected, metadata about the process used to generate the summary, information regarding references considered, utilized, etc.) attached to and/or included in the event summary.

This Overview is provided to introduce a selection of concepts in a simplified form that are further described below in the Technical Disclosure. It may be understood that this Overview is not intended to identify or emphasize key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates one or more multi-reference event summarization systems.

FIG. 2 illustrates a reference set.

FIG. 3 illustrates a method for assembling a summary using references in a reference set.

FIG. 4 illustrates a method for assembling a summary using references in a reference set.

FIG. 5 illustrates one or more computing systems in which implementations of multi-reference event summarization maybe executed.

FIG. 6 illustrates one or more methods for performing multi-reference event summarization.

### TECHNICAL DISCLOSURE

Examples herein discuss multi-reference event summarization based on references relating to a detected event. These summaries can include text and other character strings, as well as non-text information (e.g., images, charts) and metadata regarding the summary itself. A system detects an event, collects references containing information about a detected event, and then summarizes multiple references to generate a multi-reference event summary.

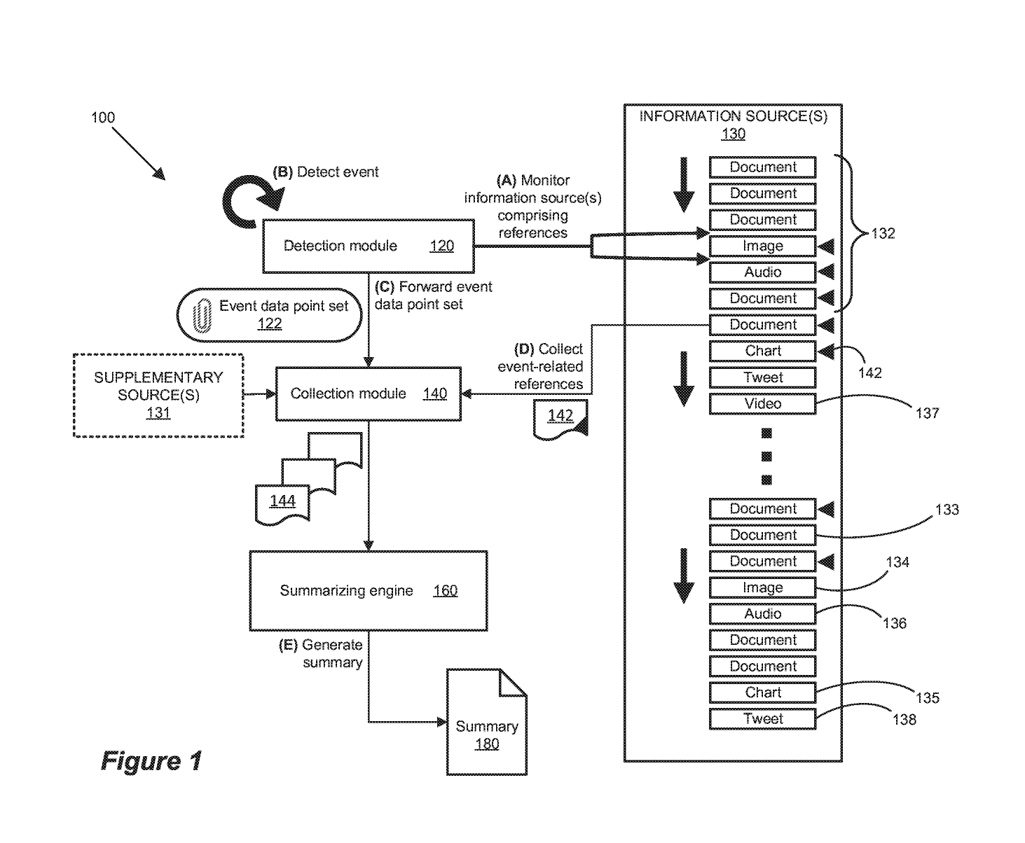

One or more implementations of system 100 for generating a multi-reference event summary are illustrated in FIG. 1. An event detection module 120 monitors (step (A) of FIG. 1) one or more information sources 130. A collection module 140 is connected to event detection module 120 in FIG. 1 so that event detection module 120 can instruct collection module 140 to collect references that relate to a detected event. Collected references can be evaluated for their suitability and content and may be provided to a summarizing engine 160 by collection module 140. Various references may be used to obtain character strings that can be assembled to create the event summary. Moreover, additional content relating to the detected event may be appended to enhance the summary and metadata (e.g., regarding references considered, utilized, etc.) attached to and/or included in the event summary.

Information source 130 is shown as a single stream of references 132 that can include text documents 133, images 134, charts 135, audio files 136, video files 137, online messages 138 (e.g., Short Message Service (SMS) messages, so-called “tweets,” email, social media and/or networking content, and blog posts) and any other subject matter capable of being monitored online or otherwise by a computing system. Each information source 130 can be a single reference source (e.g., a news feed, a news outlet, a communication or blog website, a news aggregation website) or can be a service that provides an aggregation and/or confluence of multiple reference sources. Other variations of information sources are possible.

Moreover, characteristics such as the reliability of the information source(s) can be included in event detection consideration. For example, where a summary is going to be relied upon for decision-making in areas of health or safety, the detection module 120 might only consider highly reliable information sources. In cases where summaries are used for entertainment or other casual purposes, all information sources might be monitored. This determination on which sources are used by detection module may be expressly defined by and administrator or user, or may be defined based on user responses to previously generated summaries.

Event detection module 120 can utilize one or more detection algorithms and other computer-implemented tools for evaluating references 132 available from source 130. Event detection module 120 is configured to monitor for and identify events, which can include a set of facts about something that has happened in the world. Non-limiting examples of events can include political events anywhere in the world, sporting news events, popular culture events, births, deaths, marriages, corporate events (e.g., initial public offerings, bankruptcies, mergers, stock price changes, product and service introductions, law suits and personnel changes), legal events and proceedings, community events, and military events and actions. Events may further include entities in some examples, such as individuals, groups, or organizations, and may further comprise locations, such as cities, regions, and the like. The Events may have occurred in the past, may be ongoing, or may be events that are in the future. For example, an event may include a product release date that has yet to occur. In some implementations, a detection module 120 may be tuned to look for particular language or “hit” terms in information sources 130 (e.g., the name of a person or place, an organization, a particular subject (e.g., “football,” or “campaign finance”)) and compare the language to other sources to determine whether an event has occurred.

Event detection module 120 may implement one or more detection algorithms, for example, seeking to correlate data in references, where the reference data correlations are likely to indicate the occurrence (step (B)) of an event (e.g., common dates, names, locations, and multiple occurrences of such facts, which can be characterized as “event data points”). By correlating multiple event data points within the references under consideration, a detection algorithm can evaluate the likelihood that an event has occurred. In one non-limiting example, a detection algorithm implemented by event detection module 120 will identify an event based on identified language features in various sources of information sources 130, the interval in time that sources were published for information sources 130, and links between the information sources (such as hyperlinks, and language based references to one other sources). In some operations, detection module 120 considers the inherent structure of data in the various sources to determine whether an event has occurred, for example looking at the sequencing of facts.

In some implementations, event detection module 120 may include a two-step mechanism for determining whether an event occurred. First, event detection module 120 may monitor information sources (news outlets, news feeds, and other information sources) to identify whether an event has occurred, wherein the events may include financial events, world events, sporting events, or some other similar event. Once an event is detected, event detection module 120 may then determine whether the event is relevant for a particular user or organization associated with system 100. This relevancy determination may be based on a variety of factors including, but not limited to, express indication from an administrator or user of system 100 indicating events that are relevant, or a determination based on previously identified events that administrators or users of system 100 have found to be relevant. For example, an investment organization may explicitly specify that financial events (i.e. market changes, company mergers, and the like) are relevant events. Consequently, detection module 120 may filter the financial events from other events that are detected by the system using a variety of techniques.

In at least one example, to filter relevant events from the total events identified by event detection module 120, event detection module 120 may generate a relevancy score for each of the events. This relevancy score may be based on the sources for the event, the content of the event (text, images, quantity, or other similar information), the timing that the sources were published, or any other scoring factor based on the sources of the identified event. Once the score is determined, the score may be compared to criteria, and if the score meets the criteria, the event may be identified as relevant. In contrast, if the score fails to meet the criteria, then an event will not be identified as relevant and will not be provided to collection module 140.

In addition to the express classification of events as relevant by users and administrators of system 100, detection module 120 may, in some examples, classify events as relevant based on historical preferences of the administrators or users of system 100. For example, at a first time, detection module 120 may classify an event as relevant, however, based on feedback or interaction of a user with respect to the event, detection module 120 may at time at a second time fail to classify a similar event as relevant. This may occur because the user fails to read summaries of a particular classification, the user provides that the information in a summary is not relevant to them, or any other similar method of identifying irrelevant events for a user or administrator. In contrast, if a user or administrator searches a topic further, or provides additional search techniques on an event that would otherwise fail to be classified as relevant, detection module 120 may be updated to flag similar events as relevant for summarization.

A non-limiting example of an event detection may be the death of a famous boxer. This type of event can potentially qualify as an “event” under a number of categories (e.g., sports, popular culture, news). In evaluating the stream of references, the detection module 120 might “notice” the boxer's name, multiple common dates (e.g., his date of birth and date of death), common city and state citations (e.g., city and state of birth, city and state of death), cause of death, children's names, titles, famous opponents' names, famous event names (e.g., the Olympics), and other event data. If detection module 120 finds that sources in information sources 130 includes content that qualifies as an event, the detection module can verify an event occurrence. For example, documents in information sources 130 may include text content and hyperlinks that include enough related information to be classified as an event.

Detection module 120 can annotate non-text references to provide easily-searched text files. For example, audio references 136 can include a text transcription of the audio content. Similarly, video references 137 and image references 134 can be annotated using image-recognition techniques and/or other tools to provide text-based descriptive matter for each reference. Such annotations can assist in identifying event data points and aid in detection generally.

Detection module 120 may designate specified event data points (e.g., facts that are important, prevalent, common) relating to the event as an event data point set and send (step (C) of FIG. 1) event data point set 122 (e.g., enough event data points deemed sufficient to define the event, and/or deemed sufficient to use as a key for identifying additional references that pertain to the detected event) to collection module 140, which uses the event data points to select and collect (step (D)) event-related references 142 out of event-relevant information source(s) 130. Each selected reference 142 may have a minimum number of event data points and is either stored in collection module 140 or is directly sent to summarizing engine 160.

In some implementations, in addition to or in place of collecting event-related references from information sources 130, it should be understood that collection module 140 may also gather content, such as documents, images, and the like from supplementary sources 131 that may not be used in defining an event. These supplementary sources 131 may comprise encyclopedia entries, previous articles that discuss background about an event, or any other similar supplementary resource. In identifying which of the supplementary resources should be used collection module 140 may consider the content that was identified for the event, such as persons' names related to the event, the location of the event, the type of event that occurred, or any other similar information about the event. Once the information is identified, collection module 140 may determine preferences and/or background related to the user or administrator of system 100, wherein the preferences and background information may include the user's knowledge level of these types of events, the user's knowledge of the persons involved in the events, the user's knowledge of the location, or any other similar background information for the event. This background information may be expressly provided by the user or administrator of system 100 or may be dynamically updates as summaries are generated by system 100. For example, if a first summary is generated that includes background information about a person involved in an event, then in a later report the same background information may not be gathered by collection module 140. Once the supplementary information is gathered, it may be provided with references from information sources 130 to summarizing engine 160 as reference set 144.

In some examples, in updating the information that should be provided within a summary for a user, system 100 may rely on machine learning. This machine learning may process a variety of variables to dynamically modify the way information is collected and presented for the user. These variables may include data that was previously provided to the user, any information about the user's background, any feedback that the user had provided to previously presented summaries, or any other similar information. Based on this information different events may be identified for the user, different sources may be used in generating the summary, or a different type of summary may be provided to the end user.

Reference set 144 sent to summarizing engine 160 can be processed to find and copy one or more relevant character strings that contain at least one event data point. Summarizing engine 160 can utilize one or more selection processes to examine the content in each reference in set 144 and generate a summary (step (E)) based on multiple collected references.

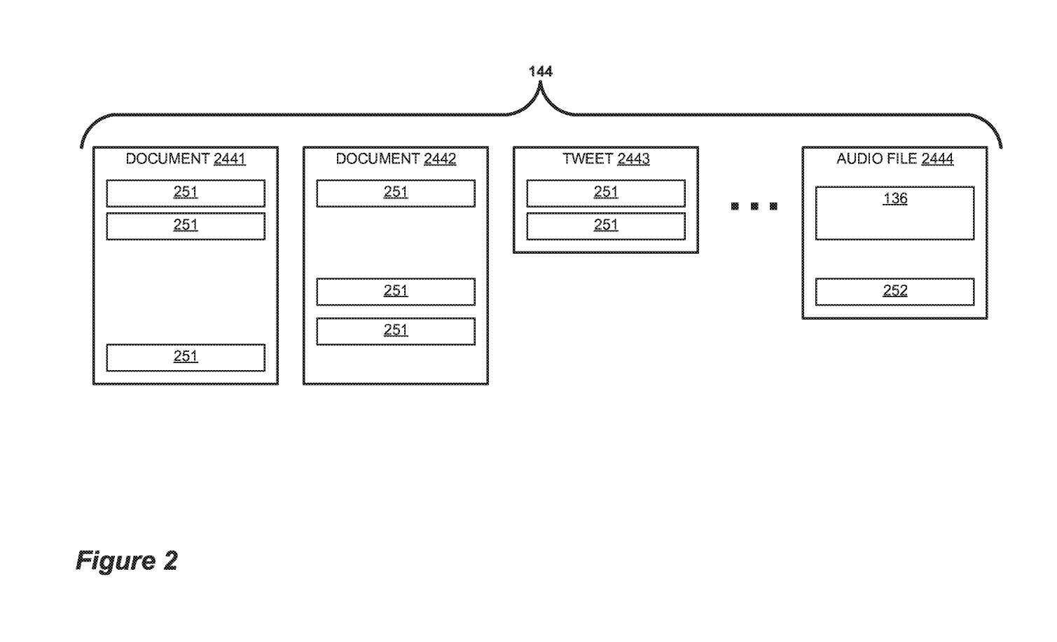

Referring to an example in FIG. 2, one set of references 144 can include document 2441, document 2442, tweet 2443, and audio file 2444. Each reference in set 144 can include a number of such character strings, such as original content character strings 251 and annotation character string 252 (generated in connection with audio file 136 of reference 2444), where a character string is defined as a sentence or other defined string that may have a minimum number of event data points (e.g., two or three).

Summarizing engine 160 can then select those character strings 251 that are appropriate for summarizing the event. In some cases, it might be best to pick character strings 251 that have a relatively large number of event data points and not much other data so that the summary is as brief as possible. In other cases, it might be more important to include as much secondary information as possible (i.e., secondary information being information that is not part of the event data points). In such implementations, picking the longest character strings with only one event data point may be more likely to include such secondary information.

In some implementations, in selecting the data for the summary from a set of references 144, summarizing engine 160 may consider the number of times that similar language was used in the set of references, the rating of the source (website or news outlet) for the references, the natural language flow or order in each of the references, or any other similar information to select specific language from each of the references. Further, in some examples, language may be modified from at least one of the references to better fit with language that is being used from other references.

In some examples, summarizing engine 160 may also consider preferences of a user or administrator of system 100 in generating summary 180. These preferences may include the length of the summary to be generated, the types of facts or information that should be included in a summary, or any other similar preferences. For example, a user may prefer facts over rumors, and may prefer summaries of a particular range of length and detail. Accordingly, summarizing engine 160 may select data from each of references 144 to accommodate the specifications of the user and provide the desired summary. In some implementations, the preferences of the user may be determined based on express requests of the user, however, it should be understood that machine learning may be used to monitor tendencies of the user to determine what types of events are of interest to the user, what information sources are of use to the user, what types of summaries are most used by the user, or some other similar information. Based on this information, system 100 may dynamically adjust the types of events that are identified for the user, adjust the sources that are used in identifying the events, adjust the type and/or length of the summaries provided to the user, or some other similar learned action based on previous interactions.

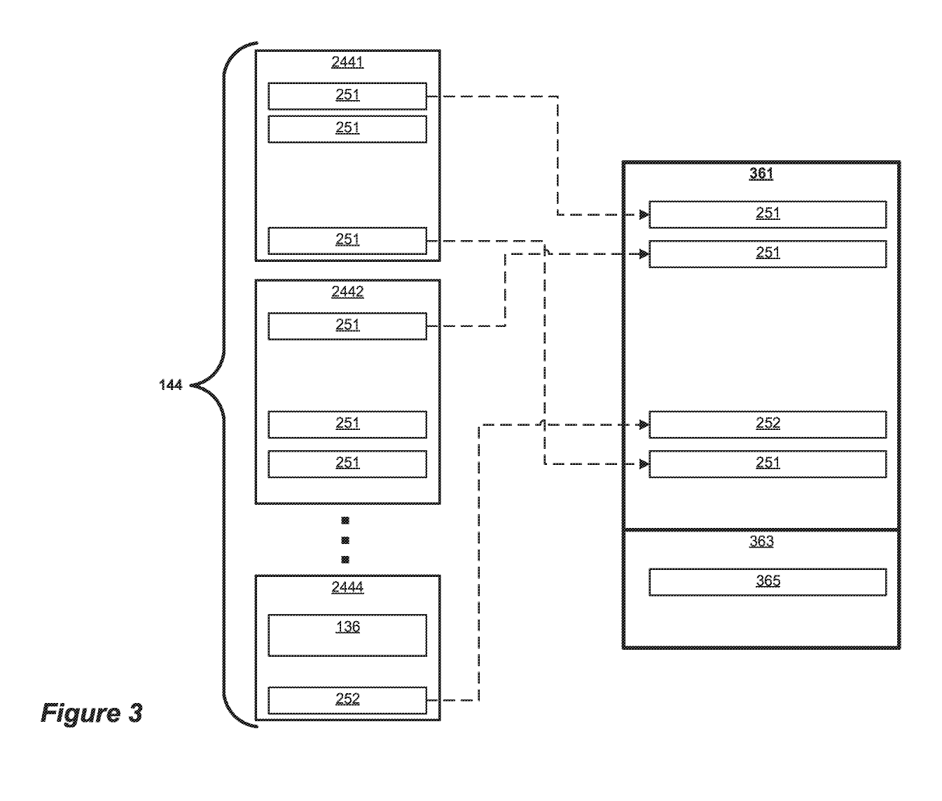

As seen in one non-limiting example in FIG. 3, the order or sequence of character strings can also be evaluated and selected when source references provide guidance in that regard. This may be done to duplicate the order in which facts are presented in the references and/or for other reasons. Such ordering of character strings and/or event data points cannot be done with systems that summarize only a single document due to the unavailability of multiple references for context and comparison. When summarizing multiple references', determinations can be made about sequencing of event data points. This sequencing may be based on a variety of factors including the number of times that data was identified, preferences of the user in receiving facts (e.g. numbers ahead of opinions), common language structure, or some other sequencing method.

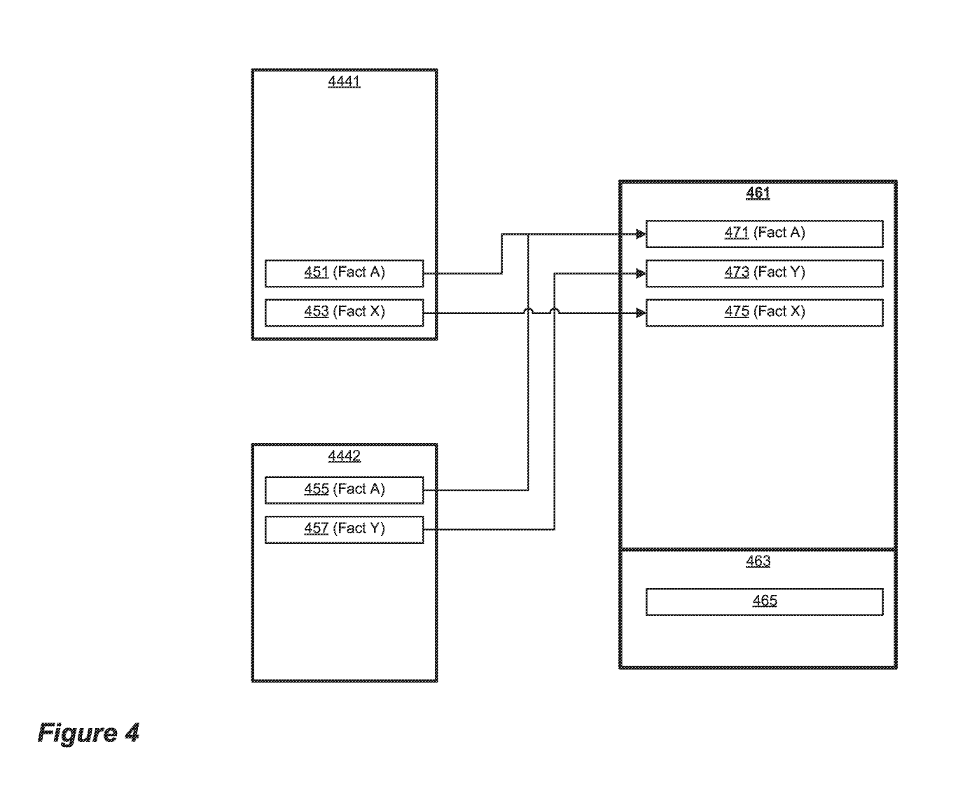

FIG. 4 illustrates one exemplary scenario in which two references 4441 and 4442 both contain event data point A. Reference 4441 also includes event data point X, while reference 4442 includes event data point Y. In both references, event data point A is presented before event data points X and Y. However, in reference 4441, both event data points A and X are presented near the end of the reference, while in reference 4442 both event data points A and Y are presented near the beginning of the reference. Based on this comparison of multiple references and their relative presentations, a summary 461 provides a presentation of event data points in character strings 471, 473, 475, which present the noted event data points in the following order: A-Y-X. Thus, summaries can be “built” as summarizing engine 160 filters and evaluates the presence of event data points and their presentation in the relevant references.

As noted, in addition to sequencing the event data relating to the detected event, summarizing engine 160 may also select character strings that are appropriate for the type of summary being generated. In one non-limiting example the summary may be intended to be as brief as possible while still conveying the salient information about the detected event. In that type of situation, short character strings that provides relatively “densely packaged” event data points can be a goal of the summarizing engine 160. In other cases, as full a description as possible might be desired, in which case longer character strings can be selected to provide additional, secondary information about the detected event, where secondary information may be any information not found in the event data points.

After preferred character strings are selected, they can be joined to form the summary. Connective text can be added to either join two character strings or to act as a bridge between the character strings (e.g., when the distance between two character strings is too great). When an event is related to a particular type of event, the summary can be started or constructed using a template. For example, if the event involves a person, specific background information such as the individual's date of birth, date of death, familial relationships, schools, honors, titles, etc. can be sought and, when found, included. If the event is weather-related, the summary might include historical information about the event, future predictions regarding impact, geographic particulars and other, similar events. Such templates might also provide a prescribed sequencing of event data points (or character strings regarding such event data points). The summary also can be constructed with a user's preferences applied. This may be implemented through the selection of reference sources, seeking specific facts that a given user is likely to find favorable, helpful or otherwise of interest.

Although described in the previous example as using a template to generate the summary, it should be understood that other natural language generation (NLG) may be used in generating the summary. In this manner, NLG techniques can be used to construct summaries dynamically based on an “interest” scoring system, a decision tree, and a system for combining observations into grammatically correct sentences and paragraphs. Thus, portions of the summary may include sentences or portions of sentences pulled directly from the sources for the event, but may also comprise generated sentences based on facts of interest and known sentence constructs.

Some detected events may be the subject of photos, video or other non-text information as well. In such cases, summarizing engine 160 can determine whether there are appropriate images, charts, etc. that should be included with the summary. Determination of the most representative image can be based, for example, on the frequency of a particular image's appearance in the references. If a given photograph or graphic is found in a large number of references, that commonly-found image can be appended to the summary to add to its information-conveying effectiveness. The same can be done with charts, graphs, etc. In some implementations, image-recognition tools can be used to determine what elements are most commonly found in images that relate to the detected event. Summarizing engine 160 can then find at least one image that possesses all of the common elements to function as a representative image for the summary. In the non-limiting example of the death of a boxer, this might be a photo from a famous match in which elements of a large number of reference images are included (e.g., the subject box, a notable opponent, an arena in which a famous bout took place).

When considering the various references, short contemporaneous online messages (e.g., tweets) might be appended to the summary as well. One or more representative messages can be found using the frequency of a large number of event data points or the association of a message source with the subject matter of the summary.

In other implementations, detection module 120 may be seeking event detection confirmation from one or more of a variety of sources and through one or more of a variety of techniques that do not include information source(s) 130 initially. Once detection module 120 detects an event, it may then instruct collection module 140 to begin finding references from information source(s) 130 relating to the detected event.

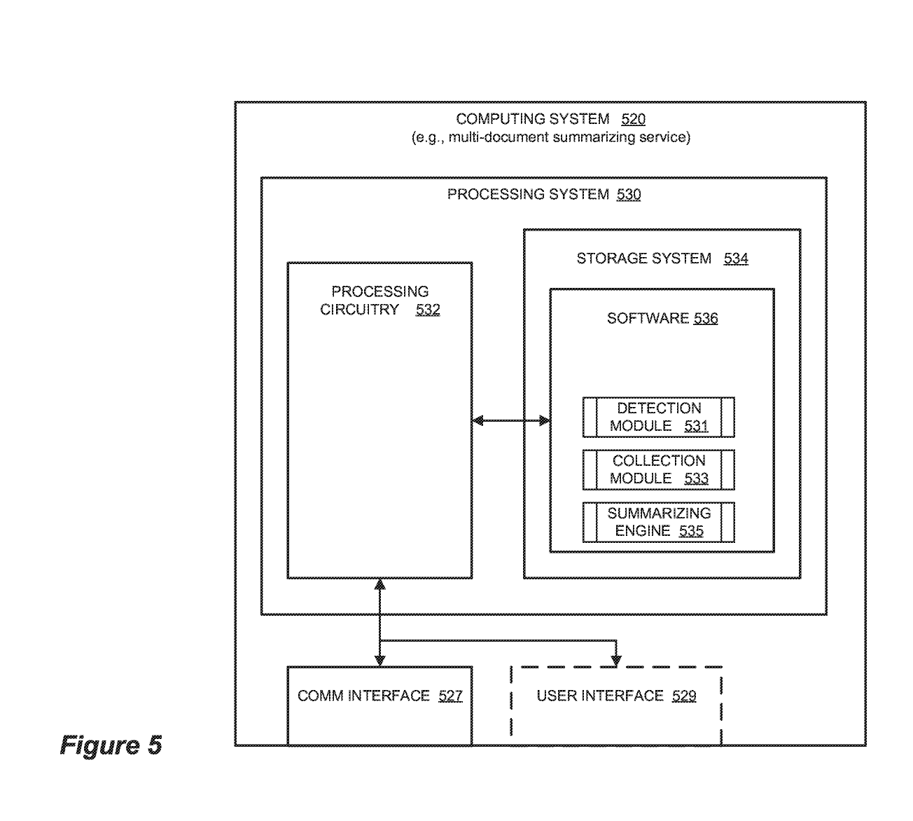

FIG. 5 illustrates a computing architecture 520 to implement one or more non-limiting exemplary multi-reference event summarizing systems and/or operations described in the Figures. Computing architecture 520 is representative of a computing architecture that may be employed as any computing apparatus, system, or device, or collections thereof, to implement one or more of the systems, methods, operations and/or devices in the Figures (e.g., the multi-document system 100 of FIG. 1). Computing architecture 520 comprises communication interface system 527, an optional user interface system 528, and processing system 530. Processing system 530 is communicatively linked to communication interface system 527 and user interface system 529. Processing system 530 includes processing circuitry 532 and memory device 534 that stores software 536 (e.g., comprising operating software, data processing applications, communication applications, management applications, operating system software).

It may be understood that computing system 520 is generally intended to represent one or more computing systems on which software 536 may be deployed and executed in order to implement multi-reference event summarizing system 100. However, computing system 520 may also be suitable as any computing system on which software 536 can be staged and from where one or both may be distributed, transported, downloaded, or otherwise provided to yet another computing system for deployment and execution, or yet additional distribution.

Communication between computing system 520 and any other computing system may occur over a communication network or networks and in accordance with various communication protocols, combinations of protocols, or variations thereof. Examples of such communication networks include intranets, internets, the Internet, local area networks, wide area networks, wireless networks, wired networks, virtual networks, software defined networks, data center buses, computing backplanes, or any other type of network, combination of network, or variation thereof. Some communication protocols that may be used include, but are not limited to, the Internet protocol (IP, IPv4, IPv6), the transfer control protocol (TCP), and the user datagram protocol (UDP), as well as any other suitable communication protocol, variation, or combination thereof.

Communication interface system 527 comprises components that communicate over communication links, such as network cards, ports, RF transceivers, processing circuitry and software, or some other communication devices. Communication interface system 527 can be configured to communicate over metallic, wireless, or optical links and can be configured to use TDM, IP, Ethernet, optical networking, wireless protocols, communication signaling, or some other communication format—including combinations thereof.

User interface system 529 comprises components that permit and facilitate interaction between a user and computing system 520. User interface system 529 may include a keyboard, a mouse, a touchscreen, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 529. In some implementations, the input and output devices may be combined in a single device, such as a display capable of displaying images and receiving touch gestures.

User interface system 529 may also include associated user interface software executable by processing circuitry 532 in support of the various user input and output devices discussed above. Separately or in conjunction with each other and other hardware and software elements, user interface software and user interface devices may support a graphical user interface, a natural user interface, or any other type of user interface. In addition, user input made with respect to the user interfaces may be input via user interface system 529. User interface system 529 can be omitted in some implementations.

Processing circuitry 532 can comprise one or more microprocessors and other processing circuitry that retrieves and executes software 536 from storage system 534. Processing circuitry 532 can be implemented within a single processing device, but can also be distributed across multiple processing devices or sub-systems that cooperate in executing program instructions. Examples of processing circuitry 532 include general purpose central processing units, application specific processors, and logic devices, as well as any other type of processing device, combinations, or variations thereof. In some examples, portions of processing circuitry 532 is physically separate from some elements of computing system 520 and area included in remote servers, cloud-based processing systems, or virtualized computing systems.

Storage system 534 can comprise any non-transitory computer readable storage media capable of storing software 536 that is executable by processing circuitry 532. Storage system 534 can also include various data structures which comprise one or more databases, tables, lists, or other data structures. Storage system 534 can include volatile and nonvolatile, removable and non-removable media implemented in any method or technology for storage of information, such as computer readable instructions, data structures, program modules, or other data. Storage system 534 can be implemented as a single storage device, but can also be implemented across multiple storage devices or sub-systems co-located or distributed relative to each other (e.g., having one or more modules 531, 533, 535 implemented separately from other modules). Storage system 534 can comprise additional elements, such as a controller, capable of communicating with processing circuitry 532. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that can be accessed by an instruction execution system, as well as any combination or variation thereof.

Software 536 can be implemented in program instructions and among other functions can, when executed by computing system 520 in general or processing circuitry 532 in particular, direct system 520 or processing circuitry 532 to operate as described herein for generating multi-reference event summaries and/or other functional systems, including one or more implementations of multi-reference event summarization. Software 536 can include additional processes, programs, or components, such as operating system software, database software, or application software and also can comprise firmware or some other form of machine-readable processing instructions executable by elements of processing circuitry 532. Software 536 may include any number of software modules to provide the group communication operations described herein.

In at least one implementation, the program instructions can include detection module 531, collection module 533, and summarizing module 535. Detection module 531 monitors one or more information sources (such as news websites and feeds) and can, in some implementations, generate notifications relating to event detections. These detections can be used to initiate multi-reference event summarization processes. Detection module 531 may periodically or continuously monitor multiple information sources, wherein the monitoring may include identifying content from the sources, identifying a time stamp associated with the content, identifying links between various content, and other similar monitoring operations. Based on the amount of similar content, related time stamps, and associated links within the sources, detection module 531 may identify that an event has occurred.

In some implementations, detection module 531 may be configured to monitor specific new outlets of interest for the user of computing system 520. In other implementations, detection module 531 may monitor a larger number of sources and, consequently, may filter events that are relevant for a user. To provide this operation, detection module 531 may identify an event using the aforementioned process. Once an event is identified, a score may be generated to rate the event in relation to a relevant category for summarization, where in the score may be based on content, the sources for the event, or any other similar information. If the score meets defined criteria, then the event may be classified as a relevant event and a summarization may be made for the event. In contrast, if the event does not meet the criteria then the event may not be classified as relevant and no summary may be generated for the event. Once the event is identified, references (such as documents, images, tweets, and the like) may be provided to the collection module.

Collection module 533 receives the references associated with the event and can retrieve additional references for the event (e.g., references from one or more information sources meeting various event data criteria). In some examples, the additional references may be retrieved from the event sources that were used in identifying the event. For example, collection module 533 may identify an article from a news resource from a time prior to the event that can provide background to the event. In addition to, or in place of, the additional references from the event sources (i.e. new outlets and the like), collection module 533 may further identify supplementary references from other sources. These sources may include encyclopedia resources, database resources, or some other resources capable of providing background information for the event. For example, if a person is identified in various news reports from detection module 531, then collection module 533 may search a database to provide background information about the person. Once the additional references are identified, the additional references and the references from the original sources may be provided to summarizing module 535.

Summarizing module 535 selects content from references to be used in summaries. The content can be character strings and other data that are assembled to generate the summary. In some implementations summarizing module 535 duplicates text and other content to assemble into a single summary document or file. Content can include original content (i.e., character strings as presented in the original reference) and annotated content (i.e., character strings generated by the multi-reference event summarizing system based on non-text reference data (e.g., audio, images, video). The summary may be generated based on the most frequently used content, the content from specific sources, or content with the most relevant data points (i.e. relevant data for the event). The summary may also be based on user preferences that can be explicitly provided or may be determined based on feedback from previously generated summaries.

In general, software 536 can, when loaded into processing circuitry 532 and executed, transform processing circuitry 532 overall from a general-purpose computing system into a special-purpose computing system customized to operate as described herein for multi-reference event summarizing. Encoding software 536 on storage system 534 can transform the physical structure of storage system 534. The specific transformation of the physical structure can depend on various factors in different implementations of this description. Examples of such factors can include, but are not limited to the technology used to implement the storage media of storage system 534 and whether the computer-storage media are characterized as primary or secondary storage. For example, if the computer-storage media are implemented as semiconductor-based memory, software 536 can transform the physical state of the semiconductor memory when the program is encoded therein. For example, software 536 can transform the state of transistors, capacitors, or other discrete circuit elements constituting the semiconductor memory. A similar transformation can occur with respect to magnetic or optical media. Other transformations of physical media are possible without departing from the scope of the present description, with the foregoing examples provided only to facilitate this discussion.

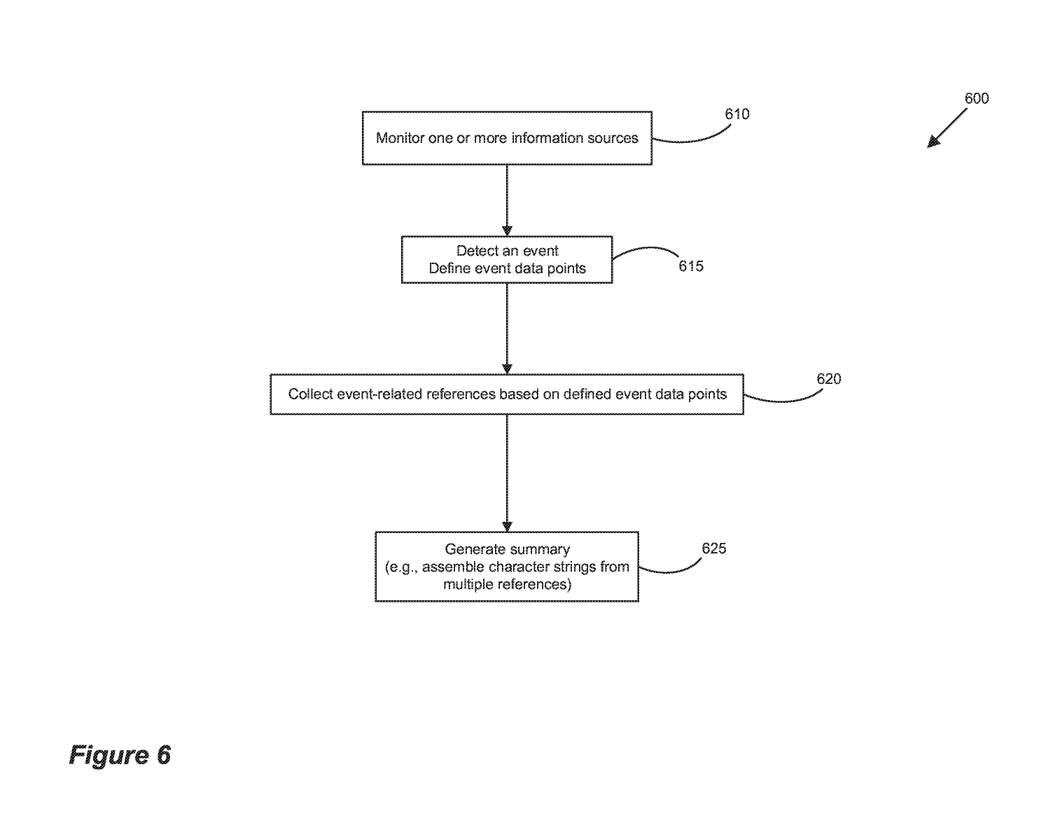

FIG. 6 illustrates a method 600 for operating a multi-reference event summarization system, one non-limiting example of which is system 100 illustrated in FIG. 1 (method 600 may be implemented as software and/or one or more modules in computing system 520 of FIG. 5). The system monitors one or more information sources (610). When an event is detected (615), a set of event data points is defined. Using the defined event data points, event-related references are collected (620). The collected references are then evaluated and a summary is generated (625), for example by assembling data (e.g., character strings, images, audio, electronic messages, video, metadata) from multiple references.

In at least one implementation, the method may include identifying references for an event based on source content (data points), time stamps for publishing the source content, the source that generated the content, and links (such as hyperlinks) that interrelate content from multiple sources. Once an event is detected, in some examples using the two-step method described above, supplemental references may be identified to support and/or provide context to the information identified in the references for the event. Once any supplemental references are identified, a summary may be generated based on content provided in the references for the event and the supplemental references.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above may be combined in various ways to form multiple implementations. As a result, the invention is not limited to the specific implementations described above, but only by the claims and their equivalents.

What is claimed is:

1. A method of operating a multi-reference event summarization system, the method comprising:
monitoring one or more information sources;
detecting an event;
collecting a reference set from at the one or more information sources, wherein the reference set comprises a plurality of documents; and
generating a summary of the event, wherein generating the event summary comprises selecting, duplicating and/or assembling data from a plurality of references in the reference set, wherein data from a reference comprises: a character string, an image, a chart, audio data, video data, electronic message data, metadata about the references from which data was selected, metadata about the process used to generate the summary.

2. The method of claim 1 wherein at least one of the information sources is a news feed.

3. The method of claim 1 wherein monitoring the one or more information sources comprises annotating non-text references.

4. The method of claim 3 wherein non-text references comprise audio, image and video data.

5. The method of claim 1 wherein generating the summary of the event further comprises ordering or sequencing event-related data within the summary.

6. The method of claim 1 wherein generating the summary of the event comprises selecting a summary template.

7. The method of claim 1 wherein detecting an event comprises correlating a minimum number of event data points within a minimum number of references during a prescribed time period.

8. The method of claim 1 wherein the summary of the event further comprises a representative image or chart.

9. A computer readable storage medium having stored thereon program instructions to operate a multi-reference event summarization system, including instructions, which when executed by one or more processors of a computing system, cause the computing system to:
monitor one or more information sources;
detect an event;
collect a reference set from at the one or more information sources, wherein the reference set comprises a plurality of documents; and
assemble a summary of the event, wherein assembling the event summary comprises selecting and duplicating a plurality of character strings from a plurality of references in the reference set.

10. The computer readable storage medium of claim 9 wherein at least one of the information sources is a news feed.

11. The computer readable storage medium of claim 9 wherein monitoring the one or more information sources comprises annotating non-text references.

12. The computer readable storage medium of claim 11 wherein non-text references comprise audio, image and video data.

13. The computer readable storage medium of claim 9 wherein generating the summary of the event further comprises ordering or sequencing event-related data within the summary.

14. The computer readable storage medium of claim 9 wherein generating the summary of the event comprises selecting a summary template.

15. The computer readable storage medium of claim 9 wherein detecting an event comprises correlating a minimum number of event data points within a minimum number of references during a prescribed time period.

16. The computer readable storage medium of claim 9 wherein the summary of the event further comprises a representative image or chart.

17. A method of producing a multi-reference event summary, the method comprising:
monitoring one or more information sources, wherein the one or more information sources comprise one or more news sources electronically supplying references, wherein each reference comprises one or more of the following: text documents, image data, audio data, video data, chart data, and electronic communication data;
detecting an event, wherein event detection comprises correlating a plurality of event data points from the monitored information sources;
collecting a reference set, wherein the reference set comprises a first document from at least one of the information sources and a second document from at least one of the information sources; and
generating an event summary, wherein generating the event summary comprises assembling event data from the reference set, wherein assembling event data from the reference set comprises combining a first character string obtained from the first document with a second character string obtained from the second document.
